(19) United States
(12) Patent Application Publication
(10) Pub. No.: US 2010/0270457 A1
(43) Pub. Date: Oct. 28, 2010

(54) Drum support for window shade

(76) Inventor: Kuen-Tin Ko, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/591,666

(22) Filed: Nov. 27, 2009

(30) Foreign Application Priority Data
Apr. 28, 2009 (TW) 098207097

(51) Int. Cl. F16M 13/00

(52) U.S. Cl. 248/674

(57) ABSTRACT

A drum support includes a seat having first and second end walls spaced along an axis and a bottom wall interconnected between the first and second end walls. The bottom wall includes a cord hole adjacent the first end wall. A space is defined between the first and second end walls and the bottom wall. The first end wall includes a first support. The second end wall includes a second support. A stop is provided on top of the second support. A spool is rotatably received in the space and includes first and second axles on two ends thereof. The first axle is rotatably supported by the first support. The second axle is rotatably supported by the second support. The stop prevents upward movement of the second axle to assure smooth rotation of the spool. Thus, winding/unwinding of the cord is reliable, preventing undesired entanglement of the cord.

### BACKGROUND OF THE INVENTION

The present invention relates to a drum support for a window shade and, more particularly, to a drum support for winding a cord of a window shade.

Window shades can provide a shield from the sun and privacy as well as decoration. There is a wide variety of types of window shades on the market, one of which is know as Roman shade including a drum support for controlling folding/unfolding of a shade unit. FIGS. 10 and 11 show a conventional cord assembly 2 for a Roman shade. The drum support 2 includes a seat 21 having opposite first and second end walls 211 and 212 and a bottom wall 214 interconnected between the first and second end walls 211 and 212. The bottom wall 214 includes a cord hole 213 adjacent the first end wall 211. A space P1 is defined between the first and second end walls 211 and 212 and the bottom wall 214. The first end wall 211 includes a first support 215, and the second end wall 212 includes a second support 216. A spool 22 is received in the space P1 and includes first and second axles 221 and 222 on two ends thereof. The first axle 221 is rotatably supported by the first support 215, and the second axle 222 is rotatably supported by the second support 216. The second support 216 is substantially semi-circular in cross section. A cord 4 is wound around the spool 22 and extended through the cord hole 213 and can be operated to fold/unfold a shade unit of the Roman shade. However, the second axle 222 is liable to move upward due to downward pulling of the cord 4 or due to the gravity of the shade unit of the Roman shade, leaving to imbalance of the spool 22. Thus, the cord 4 may be entangled (see FIG. 11) during winding of the cord 4 around the spool 22, adversely affecting folding/unfolding of the shade unit.

Thus, a need exists for an improved cord seal assembly avoiding undesired entanglement of the cord during operation.

### BRIEF SUMMARY OF THE INVENTION

The present invention solves this need and other problems in the field of smooth operation of cords by providing, in a preferred form, a drum support including a seat having first and second end walls spaced along an axis and a bottom wall interconnected between the first and second end walls. The bottom wall includes a cord hole adjacent the first end wall. A space having an upward opening is defined between the first and second end walls and the bottom wall. The first end wall includes a first support. The second end wall includes a second support. A stop is provided on top of the second support. A spool is rotatably received in the space and includes first and second axles on two ends thereof The first axle is rotatably supported by the first support. The second axle is rotatably supported by the second support. The stop prevents upward movement of the second axle to assure smooth rotation of the spool. Thus, winding/unwinding of the cord is reliable, preventing undesired entanglement of the cord.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a top, perspective view of a drum support for a window shade of a first embodiment according to the preferred teachings of the present invention.

FIG. 2 shows an exploded, top, perspective view of the drum support of the drum support of FIG. 1.

FIG. 3 shows another top, perspective view of the drum support of FIG. 1, illustrating the other end of the drum support.

FIG. 4 shows a bottom, perspective view of the drum support of FIG. 1.

FIG. 5 shows a perspective view of the drum support of FIG. 1 with a cord mounted to the drum support.

FIG. 6 shows a perspective view of a coupling board in which the drum support of FIG. 1 is mounted.

FIG. 7 shows an exploded, perspective view of a drum support of a second embodiment according to the preferred teachings of the present invention.

FIG. 8 shows a perspective view of a drum support of a third embodiment according to the preferred teachings of the present invention.

FIG. 9 shows a perspective view of the drum support of FIG. 8.

FIG. 10 shows a perspective view of a conventional drum support for a Roman shade.

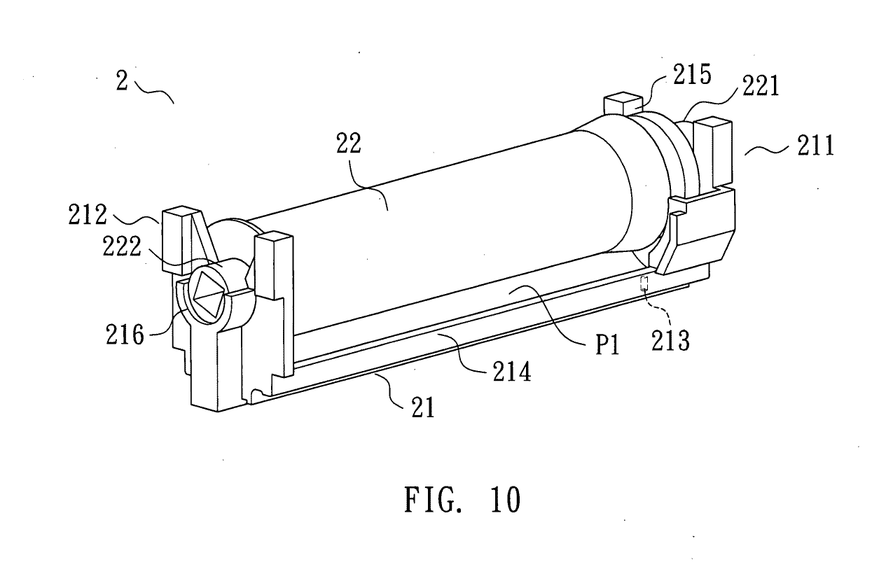

FIG. 11 shows a perspective view of the drum support of FIG. 10 with a cord mounted to the drum support.

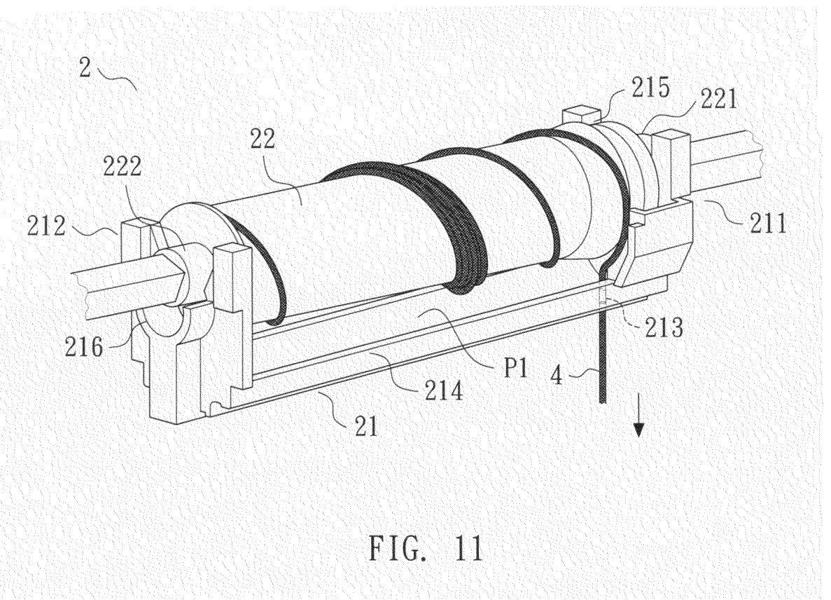

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

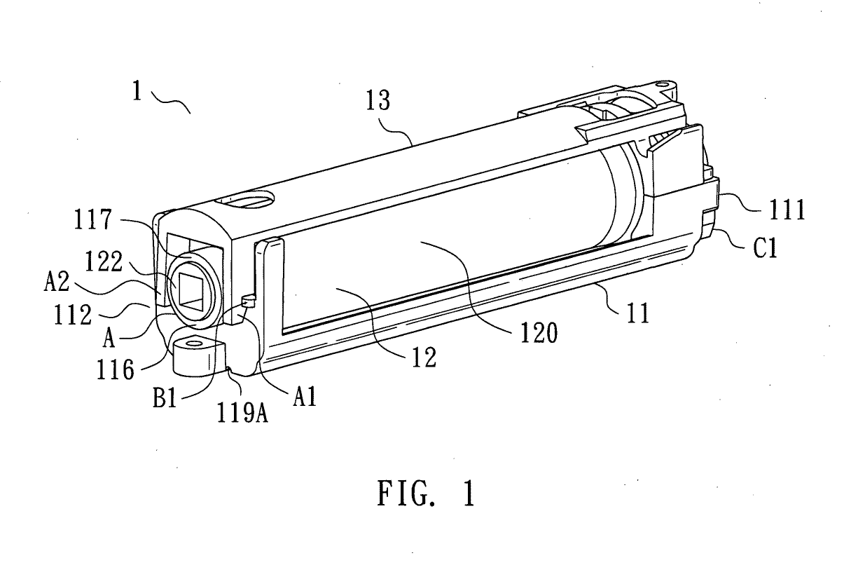

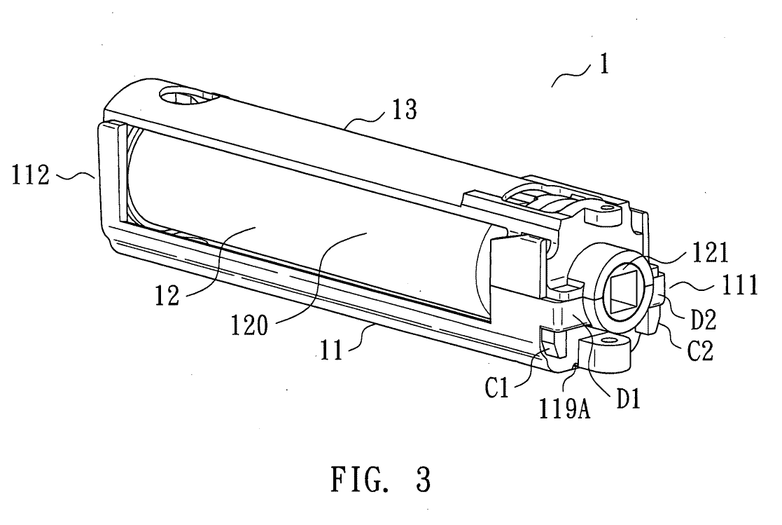

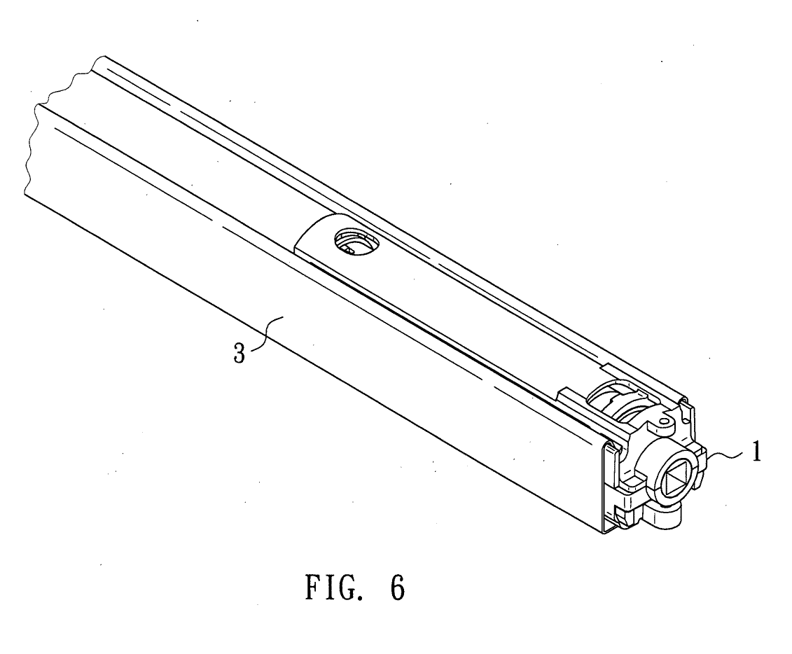

A drum support according to the preferred teachings of the present invention is shown in FIGS. 1-9 and generally designated 1. The drum support 1 can be mounted in a coupling board 3 mounted to a wall.

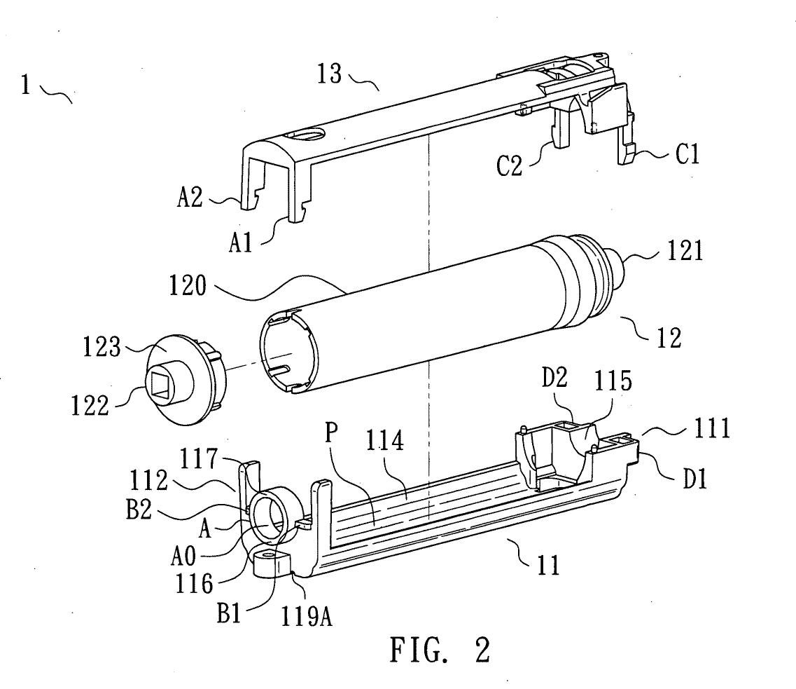

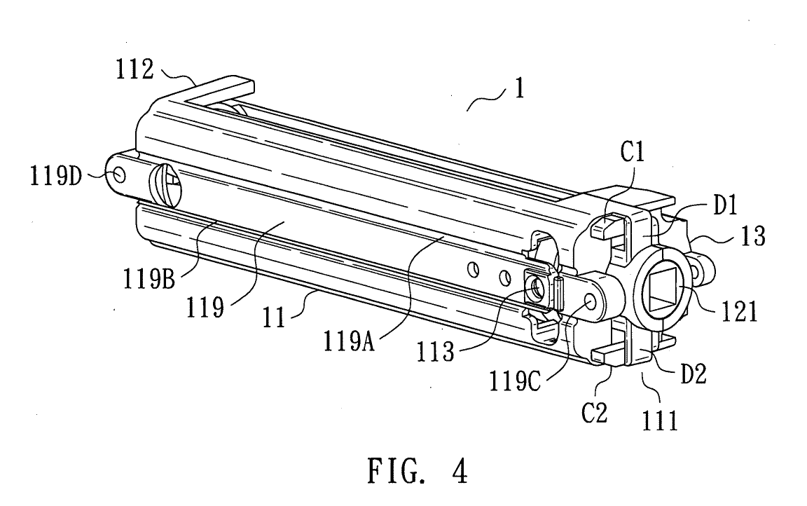

With reference to FIGS. 1 and 2, the drum support 1 includes a seat 11 including first and second end walls 111 and 112 spaced along an axis and a bottom wall 119 interconnected between the first and second end walls 111 and 112. The bottom wall 119 includes a cord hole 113 adjacent the first end wall 111. With reference to FIG. 4, the bottom wall 119 further includes two lateral rails 119A and 119B spaced in a direction perpendicular to the axis. Thus, the drum support 1 can stably slide in a track in the coupling board 3. The bottom wall 119 further includes two holes 119C and 119D through which fasteners extend to fix the seat 11 in the track.

With reference to FIG. 2, a space P having an upward opening is defined between the first and second end walls 111 and 112 and the bottom wall 114. The first end wall 111 includes a first support 115, and the second end wall 112 includes a second support 116. A stop 117 is provided on top of the second support 116. In the first embodiment, the stop 117 and the second support 116 are integrally formed as a single continuous monolithic ring A having, a hole A0.

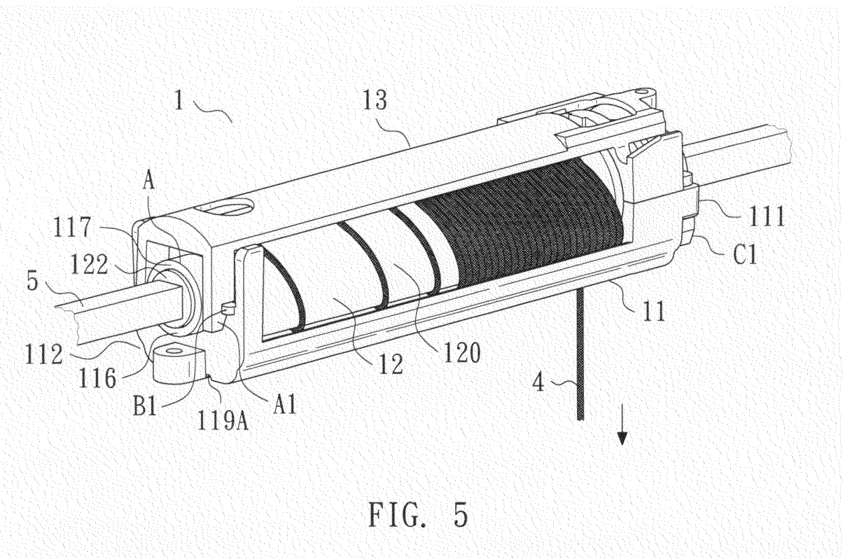

A cylindrical spool 12 is received in the space P and includes first and second axles 121 and 122 on two ends thereof. The first axle 121 is rotatably supported by the first support 115, and the second axle 122 is rotatably supported by the second support 116. In the first embodiment, the second axle 122 is formed on a side of an end cap 123 that is coupled to an end of a body 120 of the spool 12. The second axle 122 can be easily extended into the hole A0 of the ring A before the end cap 123 is coupled to the body 120 of the spool 12. A cord 4 (FIG. 5) is wound around the spool 12 and extended through the cord hole 123 for manual operation.

A shaft 5 (FIG. 5) is extended through the first and second axles 121 and 122 and the spool 12. A shade unit of a window shade is coupled to the shaft 5 such that operation of the cord 4 causes rotation of the shaft 5, which, in turn, folds or unfolds the shade unit.

With reference to FIG. 5, the stop 117 prevents upward movement of the second axle 122 due to downward pulling of the cord 4 or due to the gravity of the shade unit of the window shade. Thus, the spool 12 can rotate stably, and the cord 4 can be wound around the spool 12 without the risk of entanglement. Thus, winding/unwinding of the cord 4 can be very smooth. Although the stop 117 and the second support 116 are integrally formed as a single continuous monolithic ring A in the first embodiment, it can be appreciated that the stop 117 can be in the form of a horizontal bar above the second support 116.

With reference to FIG. 2, a cover 13 can be mounted on top of the seat 11 and the first and second supports 115 and 116. The ring A includes first and second sides spaced in the direction perpendicular to the axis. Each of the first and second sides of the ring A includes a ledge B1, B2 extending along the axis away from the first end wall 111. The cover 13 includes first and second ends spaced along the axis. The second end of the cover 13 includes two hooks A1 and A2 for coupling with the ledges B1 and B2. The first end of the cover 13 includes two resilient hooks C1 and C2. The first end wall 111 of the seat 11 includes two coupling frames D1 and D2 each having a coupling hole.

In assembly, the cover 13 is mounted on top of the spool 12 and the first and second supports 115 and 116 with the hooks A1 and A2 engaged with the ledges B1 and B2 and with the hooks C1 and C2 engaged with the coupling frames D1 and D2. Note that each hook C1, C2 is extended through the coupling hole of one of the coupling frames D1 and D2 and then coupled with a bottom side of the coupling frames D1 and

D2. Thus, the spool 12 is securely retained between the cover 13 and the seat 11.

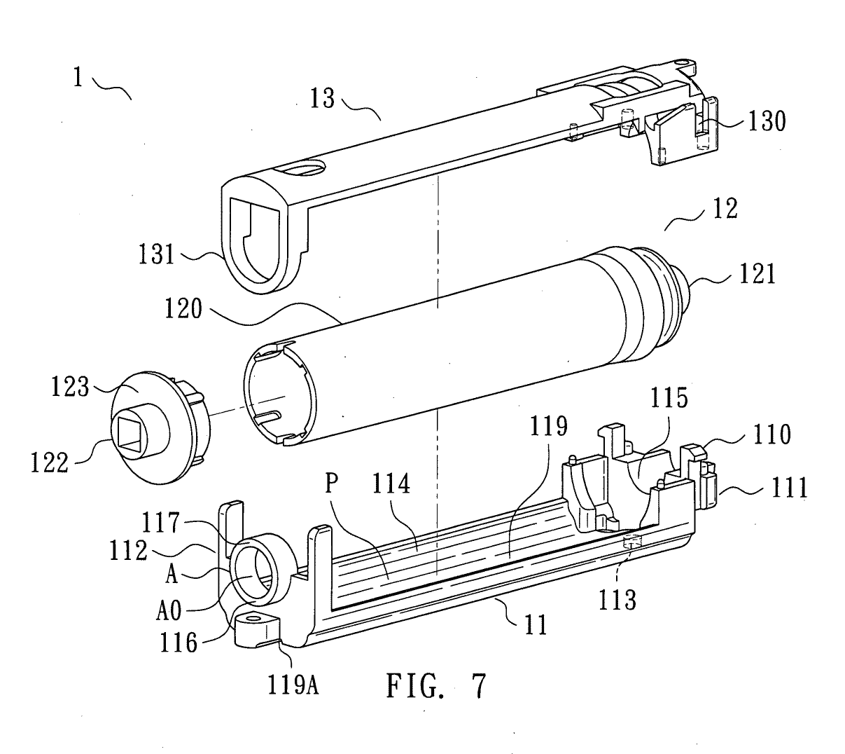

In a second embodiment shown in FIG. 7, the second end of the cover 13 can include a loop 131 for coupling with an outer portion of the ring A on the second end wall 116 of the seat 11. The first end of the cover 13 includes two coupling portions 130 in the form of slots. The first end wall 111 of the seat 11 includes two resilient hooks 110 for coupling with the coupling portions 130. It can be appreciated that the first end wall 111 of the seat 11 and the first end of the cover 13 can be releasably coupled by any other suitable provisions.

It can be appreciated that the cover 13 is not a necessary element for preventing the second axle 122 of the spool 12 from moving upward.

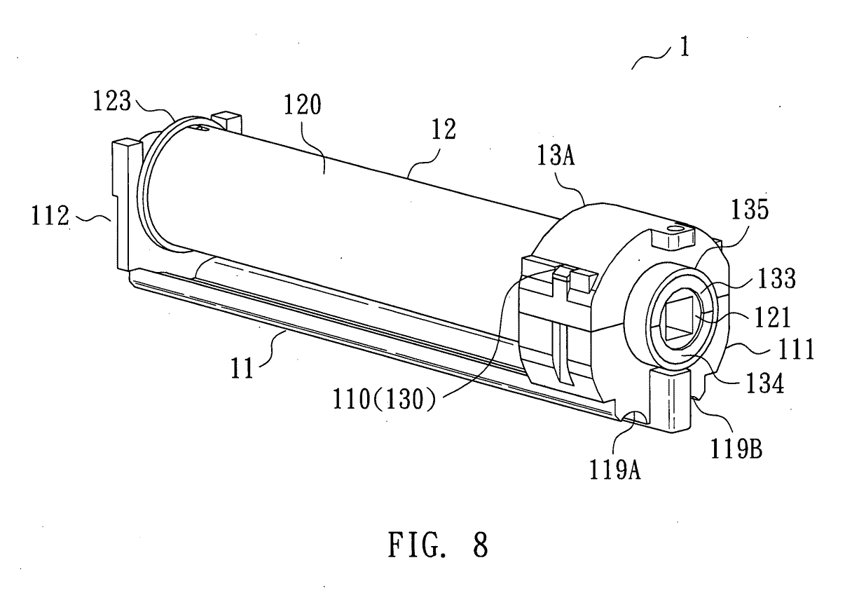

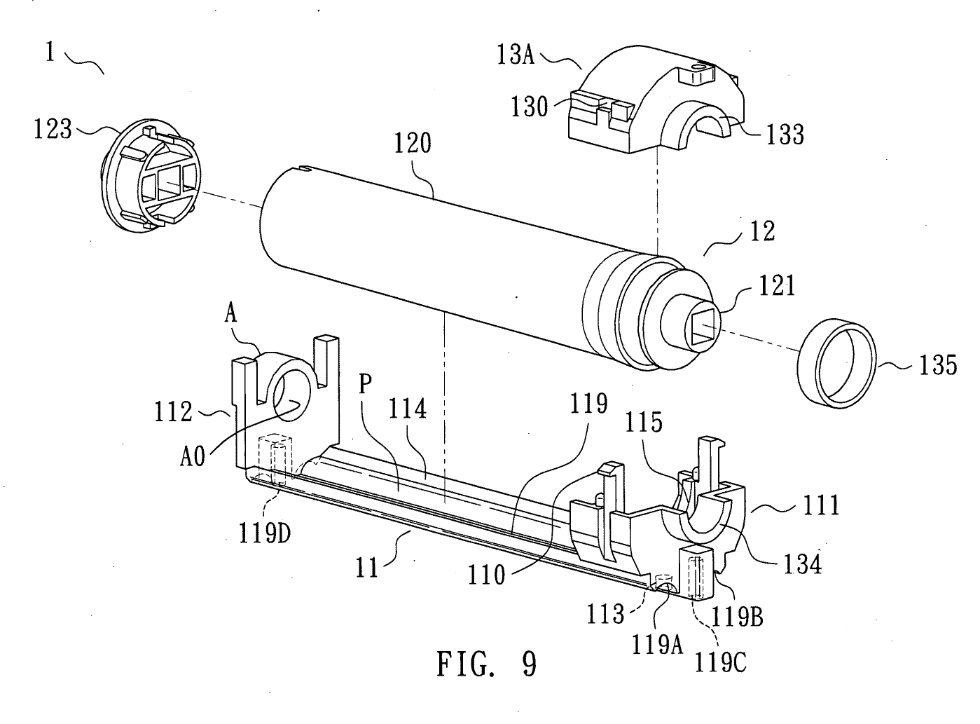

In a third embodiment shown in FIGS. 8 and 9, the cover 13A is mounted on top of the first end wall 111 of the seat 11 and the first end of the spool 12. Specifically, the cover 13A has a downwardly facing compartment. Furthermore, the cover 13A includes a first arcuate extension 133 on an end face thereof. The first arcuate extension 133 defines a downwardly facing hole. The first end wall 111 of the seat 11 includes a second arcuate extension 134 having an upwardly facing hole. The first and second arcuate extensions 133 and 134 together define a circular hole rotatably receiving the first axle 121. A positioning ring 135 is mounted around the first and second arcuate extensions 133 and 134. Thus, the cover 13A is simpler than the covers 13 in the first and second embodiments.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A drum support comprising:
a seat including first and second end walls spaced along an axis and a bottom wall interconnected between the first and second end walls, with the bottom wall including a cord hole adjacent the first end wall, with a space having an upward opening being defined between the first and second end walls and the bottom wall, with the first end wall including a first support, with the second end wall including a second support, with a stop provided on top of the second support; and
a spool rotatably received in the space and including first and second axles on two ends thereof, with the first axle rotatably supported by the first support, with the second axle rotatably supported by the second support, with the stop preventing upward movement of the second axle.

2. The drum support as claimed in claim 1, with the stop and the second support being integrally formed as a single continuous monolithic ring having a hole, and with the second axle of the seat being rotatably received in the hole of the ring.

3. The drum support as claimed in claim 2, further comprising: a cover mounted on top of the spool and the first and second supports of the seat, with the ring including first and second sides spaced in a direction perpendicular to the axis, with each of the first and second sides of the ring including a ledge extending along the axis away from the first end wall, with the cover including first and second ends spaced along the axis, with the second end of the cover including two hooks coupled with the ledges.

4. The drum support as claimed in claim 2, further comprising: a cover mounted on top of the spool and the first and second supports of the seat, with the second end of the cover including a loop, and with the loop mounted around an outer portion of the ring.

5. The drum support as claimed in claim 1, further comprising: a cover mounted on top of the first end of the spool and the first support of the seat, with the ring including a downwardly facing compartment, with the cover further including a first arcuate extension on an end face thereof, with the first arcuate extension defining a downwardly facing hole, with the first end wall of the seat including a second arcuate extension having an upwardly facing hole, with the first and second arcuate extensions together define a circular hole rotatably receiving the first axle; and a positioning ring mounted around the first and second arcuate extensions.
